(19) United States
(12) Patent Application Publication
(10) Pub. No.: US 2026/0002034 A1
(43) Pub. Date: Jan. 1, 2026

(54) HYBRID MOISTURE-PROOF LAYER AND METHOD OF MANUFACTURING SAME

(71) Applicant: KOREA ELECTRONICS TECHNOLOGY INSTITUTE, Seongnam-si (KR)

(72) Inventor: Soon Hyung KWON, Seongnam-si (KR)

(73) Assignee: KOREA ELECTRONICS TECHNOLOGY INSTITUTE, Seongnam-si (KR)

(21) Appl. No.: 19/230,345

(22) Filed: Jun. 6, 2025

(30) Foreign Application Priority Data
Jun. 28, 2024 (KR) 10-2024-0085577

(51) Int. Cl. C09D 7/61; C09D 7/40; C09D 183/16

(52) U.S. Cl. CPC C09D 7/61; C09D 7/67; C09D 183/16

(57) ABSTRACT

Disclosed are a hybrid moisture-proof layer including a base film, a first moisture-proof layer formed by curing a first solution on the base film, a second moisture-proof layer formed by curing a second solution on the first moisture-proof layer, a mixed layer formed between the first moisture-proof layer and the second moisture-proof layer, and a third moisture-proof layer formed using a deposition process on the second moisture-proof layer, and a method of manufacturing the same.

### CROSS REFERENCE TO RELATED APPLICATION

The present application claims priority to Korean Patent Application No. 10-2024-0085577, filed Jun. 28, 2024, the entire contents of which is incorporated herein for all purposes by this reference.

### TECHNICAL FIELD

The present disclosure relates to a hybrid moisture-proof layer and a method of manufacturing the same.

### BACKGROUND

In general, organic electronic devices, such as organic light emitting diodes (OLEDs) and organic solar cells, are very vulnerable to moisture and oxygen in the air. Therefore, an encapsulation process is needed to increase the lifespan of organic electronic devices.

Even when using a plastic substrate instead of a conventional glass substrate to ensure the flexibility of an electronic device, if the electronic device is manufactured without any treatment, moisture and oxygen may easily penetrate the electronic device, causing a reduction in the light emitting area or a failure such as the electronic device itself not emitting light. Therefore, a thin moisture-proof layer is required on the substrate or film.

### SUMMARY

An aspect of the present disclosure is to provide a hybrid moisture-proof layer including a moisture-proof layer formed by applying a solution followed by thermal curing or photocuring and a moisture-proof layer formed using a deposition process (ALD, CVD, sputtering, etc.) thereon.

Another aspect of the present disclosure is to provide a hybrid moisture-proof layer in which two or more moisture-proof layers are continuously formed by applying a solution followed by thermal curing or photocuring and a mixed layer is formed between the two moisture-proof layers.

Still another aspect of the present disclosure is to provide a hybrid moisture-proof layer including metal nanoparticles by adding metal nanoparticles to a thermocurable solution or a photocurable solution.

An aspect of the present disclosure provides a hybrid moisture-proof layer including a base film, a first moisture-proof layer formed by curing a first solution on the base film, a second moisture-proof layer formed by curing a second solution on the second moisture-proof layer, a mixed layer formed between the first moisture-proof layer and the second moisture-proof layer, and a third moisture-proof layer formed using a deposition process on the second moisture-proof layer.

According to an embodiment, the mixed layer may be formed by mixing and curing of the first solution and the second solution.

According to an embodiment, the mixed layer may have a higher density than the first moisture-proof layer and the second moisture-proof layer.

According to an embodiment, the second solution may include a solvent that dissolves the cured first solution.

According to an embodiment, each of the first solution and the second solution may include metal nanoparticles.

According to an embodiment, the hybrid moisture-proof layer may be configured such that the metal nanoparticles included in the first solution and the metal nanoparticles included in the second solution are different types of metals.

According to an embodiment, the third moisture-proof layer may be formed to a higher thickness with an increase in the size of defects present in the first moisture-proof layer and the second moisture-proof layer.

Another aspect of the present disclosure provides a method of manufacturing a hybrid moisture-proof layer, including preparing a base film, forming a first moisture-proof layer by applying a photocurable or thermocurable first solution onto the base film followed by photocuring or thermal curing, forming a mixed layer and a second moisture-proof layer by applying a photocurable or thermocurable second solution onto the first moisture-proof layer followed by photocuring or thermal curing, and forming a third moisture-proof layer having a predetermined thickness using a deposition process on the second moisture-proof layer.

According to an embodiment, forming the second moisture-proof layer may include applying the second solution onto the first moisture-proof layer, aging the second solution applied onto the first moisture-proof layer for a predetermined period of time, and curing the second solution.

According to an embodiment, the method of manufacturing the hybrid moisture-proof layer may further include mixing metal nanoparticles with the first solution and the second solution.

The features and advantages of the present disclosure will become more apparent from the following detailed description based on the accompanying drawings.

Before the present disclosure is described in more detail, it must be noted that the terms and words used in the present specification and claims should not be interpreted as being limited to typical meanings or dictionary definitions, but should be interpreted as having meanings and concepts relevant to the technical spirit of the present disclosure based on the rule according to which an inventor may appropriately define a concept of a term to best describe the method he or she knows for carrying out the disclosure.

According to an embodiment of the present disclosure, a hybrid moisture-proof layer is formed in various device modules, such as display modules, solar cell modules, etc., to effectively prevent the introduction of external moisture or foreign matter.

According to an embodiment of the present disclosure, in forming a moisture-proof layer to prevent penetration of external moisture or foreign matter, a moisture-proof layer manufactured by applying a photocurable or thermocurable solution and a moisture-proof layer manufactured through a deposition process are used in combination at an effective thickness ratio, so that the production lead time can be effectively reduced, and also the reliability of the moisture-proofing effect can be further improved.

According to an embodiment of the present disclosure, defects such as cracks or pinholes that occur during curing of the thermocurable solution or the photocurable solution can be effectively covered by forming a moisture-proof layer using a deposition process.

According to an embodiment of the present disclosure, a mixed layer can be formed more densely between two moisture-proof layers formed of the thermocurable solution or the photocurable solution, thereby effectively delaying moisture penetration.

According to an embodiment of the present disclosure, metal nanoparticles are included in the moisture-proof layer formed by curing of the solution, thereby effectively delaying moisture penetration.

### BRIEF DESCRIPTION OF THE DRAWINGS

The above and other aspects, features, and other advantages of the present disclosure will be more clearly understood from the following detailed description taken in conjunction with the accompanying drawings, in which:

FIG. 1 shows a hybrid moisture-proof layer according to an embodiment;

FIG. 2 shows a mixed layer of the hybrid moisture-proof layer according to an embodiment;

FIG. 3 shows the hybrid moisture-proof layer further including metal nanoparticles according to an embodiment;

FIG. 4 shows advantages of the hybrid moisture-proof layer according to an embodiment;

FIG. 5 shows a first solution that is applied onto a base film according to an embodiment;

FIG. 6 shows curing the first solution according to an embodiment;

FIG. 7 shows applying a second solution according to an embodiment;

FIG. 8 shows aging for a predetermined period of time according to an embodiment;

FIG. 9 shows curing the second solution according to an embodiment; and

FIG. 10 shows forming a third moisture-proof layer according to an embodiment.

### DETAILED DESCRIPTION

Hereinafter, a detailed description will be given of the present disclosure (with reference to the attached drawings). However, these are merely exemplary and the present disclosure is not limited to the specific embodiments described by way of example.

Referring to the attached drawings, an embodiment of the present disclosure is described in detail below.

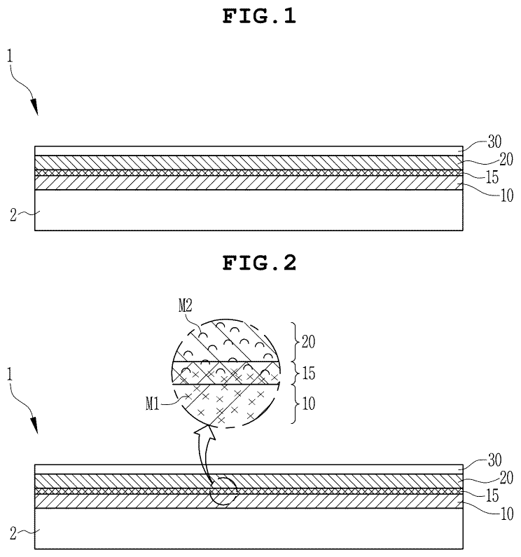

FIG. 1 shows a hybrid moisture-proof layer 1 according to an embodiment.

The hybrid moisture-proof layer 1 according to an embodiment may include a base film 2, a first moisture-proof layer 10 formed by curing a first solution on the base film 2, a second moisture-proof layer 20 formed by curing a second solution on the first moisture-proof layer 10, a mixed layer 15 formed between the first moisture-proof layer 10 and the second moisture-proof layer 20, and a third moisture-proof layer 30 formed using a deposition process on the second moisture-proof layer 20.

The base film 2 may be a part that is attached to a display, a solar cell, or various other devices. The base film 2 may be a packaging material, a cover, a pouch film, etc. requiring blocking of moisture, etc. By forming the hybrid moisture-proof layer 1 according to an embodiment on the base film 2, introduction of moisture or foreign matter from the outside may be blocked.

The base film 2 may be provided in the form of a transparent film or substrate when visibility is required as in a display module. The base film 2 may be formed of polyethylene terephthalate (PET), polycarbonate (PC), polymethyl methacrylate (PMMA), polyethylene naphthalate (PEN), polyether sulfone (PES), cyclic olefin polymer (COC), triacetylcellulose (TAC) film, polyvinyl alcohol (PVA) film, polyimide (PI) film, polystyrene (PS), K-resin-containing biaxially oriented polystyrene (BOPS), glass, or reinforced glass. Also, in modules that do not ensure transparency, substrates or films made of other materials not described herein may be used as the base film 2.

The first moisture-proof layer 10 and the second moisture-proof layer 20 may be layers formed by curing the solution. When using a process of applying a solution and curing the same, a moisture-proof layer may be formed in a shorter time at a lower cost than when using a deposition process. The first moisture-proof layer 10 may be formed by applying the first solution onto the base film 2 and curing the same. The second moisture-proof layer 20 may be formed by applying the second solution onto the first moisture-proof layer 10 and curing the same.

The first moisture-proof layer 10 and the second moisture-proof layer 20 may be stacked in the form of a thin film. The first moisture-proof layer 10 and the second moisture-proof layer 20 may be formed to a thickness necessary for moisture-proofing.

The first moisture-proof layer 10 and the second moisture-proof layer 20 may be formed of a photocurable material that is photocured by UV light or deep UV (DUV) light or a thermocurable material. For example, the first solution or the second solution may be composed of aluminum oxide (Al₂O₃), perhydropolysilazane, indium gallium zinc oxide (IGZO), inorganic polysilazane, or a combination thereof.

FIG. 2 shows the mixed layer 15 of the hybrid moisture-proof layer 1 according to an embodiment.

The mixed layer 15 may be formed between the first moisture-proof layer 10 and the second moisture-proof layer 20. The mixed layer 15 may be formed by mixing and curing of the first solution and the second solution. The mixed layer 15, which is formed by mixing and curing of the first solution and the second solution, may have a higher density than the first moisture-proof layer 10 and the second moisture-proof layer 20.

In the enlarged view of FIG. 2, a material M1 included in the first solution and a material M2 included in the second solution are indicated.

The material M1 included in the first solution and the material M2 included in the second solution may include at least one of PHPS, TiOx, SiOx, AlOx, graphene, graphene oxide, PHPS-derived SiN (PDSN), or polydimethylsiloxane (PDMS).

The second solution may include a solvent that dissolves the cured first solution. The mixed layer 15 may be formed in a process in which the second solution is applied onto the first moisture-proof layer 10 formed by curing the first solution so that a portion of the cured first solution is dissolved by the solvent included in the second solution. Accordingly, the mixed layer 15 may include at least one of PHPS, TiOx, SiOx, AlOx, graphene, graphene oxide, PHPS-derived SiN (PDSN), or polydimethylsiloxane (PDMS).

Depending on the characteristics of the materials M1, M2 included in the first solution and the second solution, when the first solution and the second solution are mixed in the mixed layer 15, the material M1 included in the first solution and the material M2 included in the second solution may fill each other's empty spaces inside the mixed layer 15. Therefore, the mixed layer 15 may be formed at a higher density than the density of the first moisture-proof layer 10 or the density of the second moisture-proof layer 20.

Since the mixed layer 15 having high density is formed in a structure in which the first moisture-proof layer 10 and the second moisture-proof layer 20 formed from the solution are provided continuously, moisture or foreign matter may be more effectively blocked by the mixed layer 15.

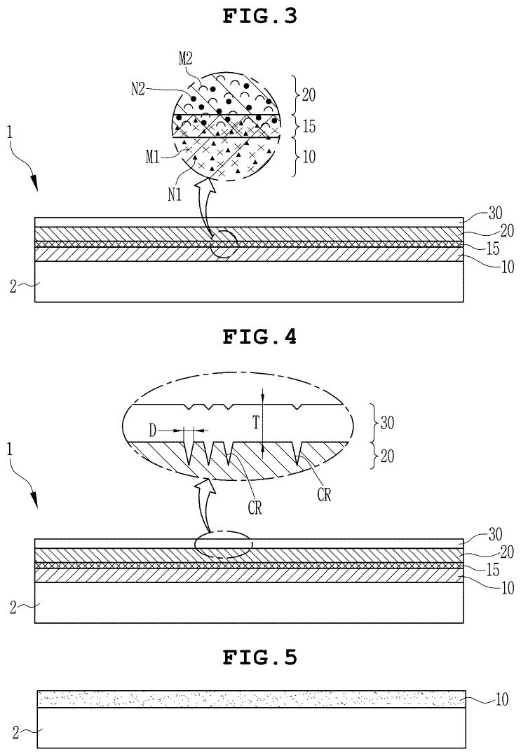

FIG. 3 shows the hybrid moisture-proof layer 1 further including metal nanoparticles according to an embodiment.

The first moisture-proof layer 10 and the second moisture-proof layer 20 of the hybrid moisture-proof layer 1 according to an embodiment may further include metal nanoparticles N1, N2. The metal nanoparticles N1, N2 may be included in the first moisture-proof layer 10 and the second moisture-proof layer 20 and may serve to improve the performance of blocking moisture or foreign matter.

The metal nanoparticles N1, N2 may include any one selected from among Zn, Al, Ag, Au, Cu, Pt, Ge, In, Ti, Fe, Ni, Pd, and Na.

Each of the first solution and the second solution forming the first moisture-proof layer 10 and the second moisture-proof layer 20 may include metal nanoparticles. The metal nanoparticles N1 included in the first solution and the metal nanoparticles N2 included in the second solution may be different types of metals. In order to improve the performance of blocking moisture or foreign matter, the types of metal nanoparticles N1, N2 included in the first solution and the second solution may be selected differently. Alternatively, the type of metal nanoparticles N1 included in the first solution may be the same as the type of metal nanoparticles N2 included in the second solution.

The metal nanoparticles N1 included in the first solution and the metal nanoparticles N2 included in the second solution may be mixed inside the mixed layer 15. Inside the mixed layer 15, the material M1 of the first solution, the material M2 of the second solution, and the two types of metal nanoparticles N1, N2 may be mixed to form a denser or more complex structure, which may increase the path for moisture or foreign matter to move. Therefore, the performance of blocking moisture or foreign matter may be improved.

FIG. 4 shows the advantages of the hybrid moisture-proof layer 1 according to an embodiment.

The third moisture-proof layer 30 may be formed using a deposition process. The third moisture-proof layer 30 may be formed using atomic layer deposition (ALD), chemical vapor deposition (CVD), sputtering, or various other deposition processes. The third moisture-proof layer 30 may be formed on the second moisture-proof layer 20. The third moisture-proof layer 30 may be formed to have a thickness less than the thickness from the first moisture-proof layer 10 to the second moisture-proof layer 20. For example, the third moisture-proof layer 30 may be formed to a thickness of ⅕ or less, ¼ or less, ⅓ or less, or ½ or less of the thickness from the first moisture-proof layer 10 to the second moisture-proof layer 20.

The deposition process may be relatively expensive and require a long time compared to the process of forming a moisture-proof layer using a solution. According to an embodiment, the hybrid moisture-proof layer 1 may be configured such that the first moisture-proof layer 10 and the second moisture-proof layer 20 are formed to be relatively thick and the third moisture-proof layer 30 is formed to be relatively thin, thus minimizing the overall manufacturing cost and also improving the moisture-proofing function of the moisture-proof layer or the structural reliability.

The first moisture-proof layer 10 and the second moisture-proof layer 20 may be formed by curing the solution through photocuring or thermal curing. As such, even when the first moisture-proof layer 10 and the second moisture-proof layer 20 are provided in the form of a thin film, partial pinholes, namely tiny cavities as if pricked by a needle, may occur during curing. Alternatively, defects such as cracks may occur. Defects such as pinholes or cracks may be formed randomly in location and size. These defects may cause problems in preventing moisture penetration. Hence, the defects may be covered by forming the third moisture-proof layer 30 using a deposition process capable of forming a uniform layer compared to a layer formed using a solution process. The third moisture-proof layer 30 may function to cover the defects by filling the space between the defects formed on the second moisture-proof layer 20 with the material. Accordingly, the most effective hybrid moisture-proof layer 1 in which the third moisture-proof layer 30 formed by deposition is attached to the first moisture-proof layer 10 and the second moisture-proof layer 20 formed by curing the solution may be manufactured.

The third moisture-proof layer 30 may be formed to a higher thickness with an increase in the size of the defects present in the first moisture-proof layer 10 and the second moisture-proof layer 20. As shown in the enlarged view of FIG. 4, as the size D of defects CR such as cracks or pinholes increases, the thickness T of the third moisture-proof layer 30 may be formed to be relatively high to cover the defects. Therefore, the thickness T of the third moisture-proof layer 30 may be determined depending on the size of the defects formed on the second moisture-proof layer 20 and desired moisture-proofing performance. However, productivity may be improved when the thickness of the third moisture-proof layer 30 is less than the thickness from the first moisture-proof layer 10 to the second moisture-proof layer 20.

According to an embodiment, the hybrid moisture-proof layer 1 may be formed by repeatedly stacking the first moisture-proof layer 10, the mixed layer 15, the second moisture-proof layer 20, and the third moisture-proof layer 30 two or more times. When the composite layers from the first moisture-proof layer 10 to the third moisture-proof layer 30 are repeatedly stacked two or more times, layers having different moisture-proofing properties are repeatedly stacked, so that moisture or foreign matter may be blocked more effectively.

FIGS. 5 to 10 show steps of a process of manufacturing the hybrid moisture-proof layer 1 according to an embodiment.

The method of manufacturing the hybrid moisture-proof layer 1 according to an embodiment may include preparing a base film 2, forming a first moisture-proof layer 10 by applying a photocurable or thermocurable first solution onto the base film 2 followed by photocuring or thermal curing, forming a mixed layer 15 and a second moisture-proof layer 20 by applying a photocurable or thermocurable second solution onto the first moisture-proof layer 10 followed by photocuring or thermal curing, and forming a third moisture-proof layer 30 having a predetermined thickness using a deposition process on the second moisture-proof layer 20.

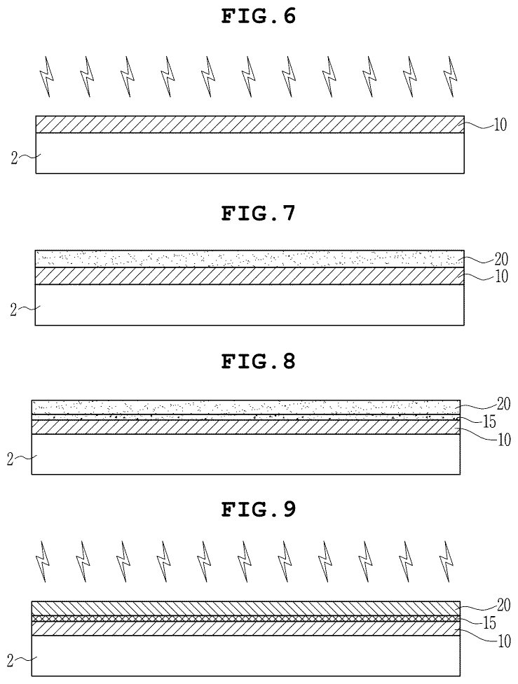

FIG. 5 shows the first solution that is applied onto the base film 2 according to an embodiment. FIG. 6 shows curing the first solution according to an embodiment.

As shown in FIG. 5, in preparing the base film 2, the base film 2 may be prepared.

Forming the first moisture-proof layer 10 may include applying a photocurable or thermocurable first solution onto the base film 2 and curing the first solution applied onto the base film 2.

In applying the first solution, the first solution may be applied to a predetermined thickness onto the base film 2 as shown in FIG. 5. Applying the first solution may be performed by subjecting a photocurable or thermocurable solution to a process such as spin coating, etc.

As shown in FIG. 6, curing the first solution may include applying heat or light at a predetermined wavelength to the first solution. Photocuring may be performed by applying ultraviolet (UV) light or deep UV light (180-600 nm) to the first solution. Thermal curing may be performed by heating the first solution to a predetermined temperature.

FIG. 7 shows applying the second solution according to an embodiment. FIG. 8 shows aging for a predetermined period of time according to an embodiment. FIG. 9 shows curing the second solution according to an embodiment.

Forming the second moisture-proof layer 20 may be conducted after the first moisture-proof layer 10 is formed. Forming the second moisture-proof layer 20 may include applying a second solution onto the first moisture-proof layer 10, aging the second solution applied onto the first moisture-proof layer 10 for a predetermined period of time, and curing the second solution.

In applying the second solution, the second solution may be applied to a predetermined thickness onto the first moisture-proof layer 10 as shown in FIG. 7. Applying the second solution may be performed by subjecting a photocurable or thermocurable solution to a process such as spin coating, etc.

Aging the second solution is a step in which the second solution applied onto the first moisture-proof layer 10 is maintained for a predetermined period of time. As shown in FIG. 8, in aging the second solution, the solvent included in the second solution is able to dissolve the cured first solution, and portions of the first solution and the second solution may be mixed, forming a mixed layer 15. The time set in aging the second solution may be determined depending on the type or concentration of the solvent of the second solution capable of dissolving the cured first solution. When the solvent of the second solution is able to dissolve the cured first solution well, aging may be conducted for only a short time. The aging time may be set longer as it is difficult for the solvent of the second solution to dissolve the cured first solution.

As shown in FIG. 9, curing the second solution may include applying heat or light at a predetermined wavelength to the second solution. Photocuring may be performed by applying ultraviolet (UV) light or deep UV light (180-600 nm) to the second solution. Thermal curing may be performed by heating the second solution to a predetermined temperature. When the second solution is cured, the mixed layer 15 may also be cured.

When the first solution or the second solution includes aluminum oxide (Al₂O₃), perhydropolysilazane, indium gallium zinc oxide (IGZO), or inorganic polysilazane, the molar concentration may be set to 0.2 M to 2 M and the process temperature may be set to 80° C. to 150° C. to thus form the first moisture-proof layer 10 having effective properties and thickness.

If the process temperature is lower than 80° C., it is difficult to form a film or coating film of a solution material during the process, whereas if the process temperature exceeds 150° C., the formed film or coating film may bend or break. Hence, it is preferable to conduct forming the first moisture-proof layer 10 and the second moisture-proof layer 20 in the process temperature range of 80° C. to 150° C.

In addition, if the molar concentration is less than 0.2 M, it is difficult to form a film or coating film due to weak supporting properties during the process, whereas if the molar concentration exceeds 2 M, it is difficult to obtain visibility upon application to modules that require visibility, such as displays, etc., so the visibility required by the applied module cannot be satisfied. Hence, it is possible to ensure process reliability and structural attachment of the first moisture-proof layer 10 and the second moisture-proof layer 20 in the molar concentration range of 0.2 M to 2 M.

The method of manufacturing the hybrid moisture-proof layer 1 according to an embodiment may further include mixing metal nanoparticles with the first solution and the second solution. Mixing the metal nanoparticles may be performed before forming the first moisture-proof layer 10. The first moisture-proof layer 10 and the second moisture-proof layer 20 may be formed using the first solution and the second solution mixed with metal nanoparticles.

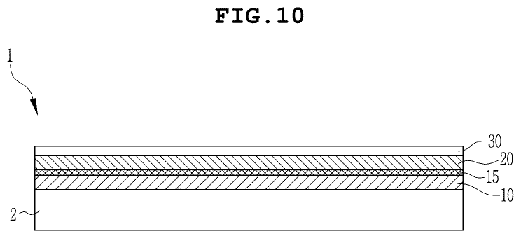

FIG. 10 shows forming the third moisture-proof layer 30 according to an embodiment.

Forming the third moisture-proof layer 30 may be conducted using a deposition process. The deposition process that may be used to form the third moisture-proof layer 30 may be a known atomic layer deposition process, chemical vapor deposition, sputtering, etc. A detailed description of each deposition process is omitted.

The time taken to perform the deposition process in forming the third moisture-proof layer 30 may vary depending on the set thickness of the third moisture-proof layer 30. Forming the third moisture-proof layer 30 may be conducted by depositing a material on the second moisture-proof layer 20 having defects such as pinholes or cracks. After completion of formation of the third moisture-proof layer 30, a hybrid moisture-proof layer 1 may be formed in which the defects formed on the second moisture-proof layer 20 are covered by the third moisture-proof layer 30.

As described above, according to an embodiment, by continuously forming the first moisture-proof layer 10 and the second moisture-proof layer 20 through a solution curing process, the mixed layer 15 having high density may be formed between the first moisture-proof layer 10 and the second moisture-proof layer 20, thereby improving the moisture-proofing function. Also, the third moisture-proof layer 30 may be formed to cover the second moisture-proof layer 20 using a deposition process, thus covering defects that may be present in the first moisture-proof layer 10 and the second moisture-proof layer 20, thereby improving the moisture-proofing function.

The present disclosure has been described in detail above through specific embodiments. This description is merely an example of applying the principles of the present disclosure, and other configurations may be further included without departing from the scope of the present disclosure.

What is claimed is:

1. A hybrid moisture-proof layer, comprising:
a base film;
a first moisture-proof layer formed by curing a first solution on the base film;
a second moisture-proof layer formed by curing a second solution on the first moisture-proof layer;
a mixed layer formed between the first moisture-proof layer and the second moisture-proof layer; and
a third moisture-proof layer formed using a deposition process on the second moisture-proof layer.

2. The hybrid moisture-proof layer according to claim 1, wherein the mixed layer is formed by mixing and curing of the first solution and the second solution.

3. The hybrid moisture-proof layer according to claim 1, wherein the mixed layer has a higher density than the first moisture-proof layer and the second moisture-proof layer.

4. The hybrid moisture-proof layer according to claim 1, wherein the second solution comprises a solvent that dissolves the cured first solution.

5. The hybrid moisture-proof layer according to claim 1, wherein each of the first solution and the second solution comprises metal nanoparticles.

6. The hybrid moisture-proof layer according to claim 5, wherein the metal nanoparticles contained in the first solution and the metal nanoparticles contained in the second solution are different types of metals.

7. The hybrid moisture-proof layer according to claim 1, wherein the third moisture-proof layer is formed to a higher thickness with an increase in a size of defects present in the first moisture-proof layer and the second moisture-proof layer.

8. The hybrid moisture-proof layer according to claim 1, wherein the first moisture-proof layer, the mixed layer, the second moisture-proof layer, and the third moisture-proof layer are repeatedly stacked two or more times.

9. A method of manufacturing a hybrid moisture-proof layer, comprising:
preparing a base film;
forming a first moisture-proof layer by applying a photocurable or thermocurable first solution onto the base film followed by photocuring or thermal curing;
forming a mixed layer and a second moisture-proof layer by applying a photocurable or thermocurable second solution onto the first moisture-proof layer followed by photocuring or thermal curing; and
forming a third moisture-proof layer having a predetermined thickness using a deposition process on the second moisture-proof layer.

10. The method according to claim 9, wherein forming the second moisture-proof layer comprises:
applying the second solution onto the first moisture-proof layer;
aging the second solution applied onto the first moisture-proof layer for a predetermined period of time; and
curing the second solution.

11. The method according to claim 9, further comprising mixing metal nanoparticles with the first solution and the second solution.
